(19) United States
(12) Patent Application Publication
(10) Pub. No.: US 2014/0305343 A1
(43) Pub. Date: Oct. 16, 2014

(54) Slow Release Phosphocement

(71) Applicants: Eyal Yehiel Vultz, Kfar Saba (IL); Aharon Weissman, M.P. Misgav (IL); Bassam Massri, Haifa (IL); Eyal Ginzberg, Zikhron-Yaakov (IL); Ron Frim, Haifa Bay (IL)

(72) Inventors: Eyal Yehiel Vultz, Kfar Saba (IL); Aharon Weissman, M.P. Misgav (IL); Bassam Massri, Haifa (IL); Eyal Ginzberg, Zikhron-Yaakov (IL); Ron Frim, Haifa Bay (IL)

(73) Assignee: IMI TAMI Institute for Research and Development Ltd., Haifa Bay (IL)

(21) Appl. No.: 14/117,103

(22) PCT Filed: Nov. 30, 2011
(86) PCT No.: PCT/IL11/00912

§ 371 Date: Jan. 10, 2014

Related U.S. Application Data
(60) Provisional application No. 61/485,130, filed on May 12, 2011.

(51) Int. Cl. C04B 28/34; C04B 22/12; C04B 14/30

(52) U.S. Cl. CPC C04B 28/34; C04B 14/304; C04B 22/126; C04B 2103/20
USPC 106/691

(57) ABSTRACT

A mixture suitable for use in forming a magnesium silico-phosphate cement is disclosed. The mixture comprises particles of MgO at least partially coated with an additive adapted to alter the setting time of said cement cast; a phosphate salt or acid chosen that will provide a binder product characterized by the empirical chemical formula MMgPO₄.6H₂O; and an aggregate phase chosen from the group containing (a) CaSiO₃, (b) MgSiO₃, (c) SiO₂, (d) fly ash, (e) sea sand, and (f) any combination thereof. Coating the MgO particles provides better control of the alteration of the setting time and better physical properties of the set cement. Methods for making the mixture and for preparing a cement cast based on the mixture are also disclosed.

### REFERENCE TO RELATED APPLICATION

This application claims priority from U.S. Provisional Patent Application No 61/485,130, filed 12 May 2011.

### FIELD OF THE INVENTION

This invention relates in general to magnesium silico-phosphate cements that contain additives for altering the setting time of their casts. In particular, it relates to magnesium silico-phosphate cements in which the magnesia component of the cement is at least partially coated by a retardant.

### BACKGROUND OF THE INVENTION

Because of their rapid setting, high strength, and strong adhesion to existing concrete, magnesium silico-phosphate cements, (MSPC) and in particular ammonium magnesium silico-phosphate (monoammonium phosphate, or MAP) cements (which comprise inter alia MgO and a soluble phosphate salt) are widely used as patching mortar for roads, airport runways, and other concrete repair applications. While rapid setting can be a positive characteristic in situations such as road or runway repair where minimization of downtime is a goal, too rapid setting can be a drawback as it limits the amount of time during which the cement's cast can be worked before it sets. In order to control the setting time, additives have been developed, primarily to lengthen the time before the cement cast sets. The most frequently used retardants for these cements are based on borate salts or boric acid, which can extend the time during which the cement is workable from about 10 minutes to about half an hour (see, e.g. U.S. Pat. No. 3,960,580 and U.S. Pat. No. 7,160,383). It should be mentioned here that the amount of retardant that can be added is limited to about 1-2% w/w, which extends the setting time by only 10 minutes. Larger amounts of retardant can further extend the setting time, but at the expense of significant deterioration in the compressive strength of the cement cast after it has set.

Other retardant systems have been proposed to overcome these difficulties. For example, U.S. Pat. No. 4,786,328 discloses the use of polycarboxylic acids (e.g. citric acid) or polyphosphonic acids (e.g. nitrilotris(methylene)tris(phosphonic acid). These compounds do not significantly extend the setting time of the cement cast, however. U.S. Pat. No. 6,783,799 discloses the use of fluorosilicates as retardants. In this case, however, the primary means by which the setting time is extended is to delay for as long as possible the mixing of the acid and base fractions of the cement mix, presumably to reduce the rate of formation of the complex hydrated salt MMgPO₄.6H₂O, where M is an alkali metal or NH₄⁺. Due to the high exothermicity of the chemical reaction between the cement and added water (e. g. ΔHᵣₓₙ˜−88 kcal/mol for formation of KMgPO₄.6H₂O), the addition of water leads to a rise in temperature, causing the process to undergo auto-acceleration. Simple fluoride salts have also been proposed as retardants for phosphate cements. For example, U.S. Pat. No. 6,458,423 teaches the use of a number of compounds including NaF and CaF₂ for use as retardants for phosphate cements. There is no evidence, however, that these retardants are any more effective than the borate salts currently considered most effective. U.S. Pat. No. 4,758,278 discloses the use of magnesium ferrate, prepared by heating magnesium oxide particles in the presence of ferric oxide, as a retardant. While this method did succeed in approximately doubling the setting time of the resulting cast, it requires an additional preparative step, and even with the use of magnesium ferrate, setting times were typically no longer than those obtained by the use of borate retardants.

PCT Patent application PCT/IL2009/000139, the contents of which are hereby incorporated by reference, discloses a new family of retardants and accelerators for MSPCs. This application discloses a cement mixture comprising MgO, KH₂PO₄, and an aggregate phase, to which an additive containing an anion of the form [MF₆]ⁿ⁻ is added in a quantity sufficient to affect the setting time of the resulting cast. It was found, for example, that for M=Ti or Zr, the additive acted as an effective retardant that did not adversely affect the properties of the hardened cast. The retardant is either added as a powder to the dry cement mix or in solution with the addition of water to the raw materials in the mixer.

All of the above solutions to the problem of altering the setting time of a phosphate cement have in common that they rely on addition the retardant or accelerator as a separate component. Care must thus be taken to add the retardant or accelerant at the proper time, at the proper rate, and in the proper amount. A phosphate cement that contains an accelerant or retardant as part of one of the components of the cement mix rather than as a separate additive, while having improved physical properties, thus remains a long-felt yet unmet need.

### SUMMARY OF THE INVENTION

The present invention is designed to meet this long-felt need. The magnesia particles within the cement mix are at least partially coated with a retardant. The presence of the retardant as a coating on the magnesia particles has the effects of making the cement mix easier to use and store; of improving the qualities of the mix; improving the alteration of the setting time; and improving the physical properties (e.g. workability) of the cast.

It is thus an object of the present to disclose mixture suitable for use in forming a magnesium silico-phosphate cement, said mixture comprising: (1) particles of MgO; (2) an additive adapted to alter the setting time of said cement; (3) a phosphate salt or acid chosen that will provide a binder product characterized by the empirical chemical formula MMgPO₄.6H₂O; and (4) an aggregate phase chosen from the group containing (a) CaSiO₃, (b) MgSiO₃, (c) SiO₂, (d) fly ash, (e) sea sand, and (1) any combination thereof. It is within the essence of the invention wherein said particles of MgO are at least partially coated with said additive.

It is a further object of this invention to disclose such a mixture, wherein said phosphate salt or acid has the chemical formula MₓH_{y}PO₄ (1≦x≦3, y=3−x), M being chosen from the group consisting of H, Li, Na, K, Rb, Cs, NH₄, and any combination of the above.

It is a further object of this invention to disclose such a mixture, wherein said binder product is isomorphic with NH₄MgPO₄.6H₂O.

It is a further object of this invention to disclose such a mixture, wherein said additive is a retardant.

It is a further object of this invention to disclose such a mixture as defined in any of the above, wherein said additive is selected from the group consisting of (a) alkali metal salts of [MF₆]ⁿ⁻, (b) alkaline earth metal salts of [MF₆]ⁿ⁻, (c) HₙMF₆, and (d) any combination thereof; and further wherein M represents any element that can form with fluorine an anion of empirical formula [MF₆]ⁿ⁻ and n represents a positive integer.

It is a further object of this invention to disclose such a mixture, wherein M is chosen from the group consisting of (a) P (n=1), (b) Sb (n=1), (c) Si (n=2), (d) Ti (n=2), (e) Zr (n=2), (f) Al (n=3), and (g) any combination thereof.

It is a further object of this invention to disclose such a mixture, wherein said additive is chosen from the group consisting of (a) Na₂TiF₆; (b) K₂TiF₆; (c) H₂TiF₆; and (d) any combination of the above.

It is a further object of this invention to disclose such a mixture as defined in any of the above, wherein said additive is present in an amount of between 0.05% and 5% by weight based upon the weight of dry cement.

It is a further object of this invention to disclose such a mixture as defined in any of the above, wherein at least 90% of said particles of MgO have sizes of between 0.1 μm and 100 μm.

It is a further object of this invention to disclose such a mixture as defined in any of the above, wherein said additive is coated upon said particles of MgO in a thickness of at least 0.5 monolayer.

It is a further object of this invention to disclose such a mixture as defined in any of the above, wherein said additive is coated upon said particles of MgO in a thickness of at least one monolayer.

It is a further object of this invention to disclose such a mixture as defined in any of the above, wherein said MgO particles coated with additive are the products of a process of spray drying.

It is a further object of this invention to disclose such a mixture, wherein said MgO particles coated with additive are the products of a process comprising steps of preparing a slurry by adding a predetermined amount of said additive to a predetermined volume of water; adding said particles of said MgO to said slurry; feeding said addition product to a spray dryer; and spray-drying said addition product, thereby producing at least partially coated particles of MgO.

It is a further object of this invention to disclose such a mixture as defined in any of the above, wherein, upon addition of water, a magnesium silico-phosphate cement cast is formed, said cement cast having an initial setting time of 45 minutes as determined according to standard EN 196-3.

It is a further object of this invention to disclose such a mixture as defined in any of the above, wherein, upon addition of water, a magnesium silico-phosphate cement cast is formed, said cement cast having a final setting time of 48 minutes as determined according to standard EN 196-4.

It is a further object of this invention to disclose such a mixture as defined in any of the above, wherein, upon addition of water, a magnesium silico-phosphate cement cast is formed, said cement cast having workability of at least 255 mm as determined according to standard EN 12350-5.

It is a further object of this invention to disclose such a mixture as defined in any of the above, wherein, upon addition of water, a magnesium silico-phosphate cement cast is formed, said cement cast having workability at least as great as the maximum that can be measured using the instrumentation specified according to standard EN 12350-5.

It is a further object of this invention to disclose such a mixture as defined in any of the above, wherein the ratio of uncoated MgO:phosphate:aggregate is 20:35:45 by weight.

It is a further object of this invention to disclose a method for producing a mixture suitable for use in forming magnesium silico-phosphate cement, said method comprising: preparing a slurry comprising a predetermined amount of an additive adapted to alter the setting time of a magnesium silico-phosphate cement in a predetermined volume of water; adding a predetermined quantity of MgO to said slurry; feeding the product of said step of adding into a dryer; drying said product, thereby producing particles of MgO at least partially coated with said additive; mixing said coated particles of MgO with said phosphate salt or acid and aggregate.

It is a further object of this invention to disclose such a method, wherein said step of drying is chosen from the group consisting of spray drying, freeze drying, and drum drying.

It is a further object of this invention to disclose such a method, wherein said step of feeding the product of said step of adding into a dryer comprises a step of feeding the product into a spray dryer, and said step of drying comprises a step of spray drying.

It is a further object of this invention to disclose such a method, additionally comprising a step of operating said spray dryer under conditions adapted to produce droplets of sizes between 0.1 μm and 200 μm.

It is a further object of this invention to disclose such a method, additionally comprising a step of operating said spray dryer under conditions adapted to produce particles, at least 90% of which have sizes of between 0.1 μm and 100 μm.

It is a further object of this invention to disclose such a method, wherein said step of spray drying additionally comprises a step of maintaining the temperature of the air exiting the spray dryer above 100° C.

It is a further object of this invention to disclose such a method, wherein said step of spray drying additionally comprises a step of maintaining the temperature of the air exiting the spray dryer at about 105° C.

It is a further object of this invention to disclose a method as defined in any of the above, wherein said additive chosen from the group consisting of H₂TiF₆; Na₂TiF₆; K₂TiF₆; and any combination of the above.

It is a further object of this invention to disclose a method as defined in any of the above, wherein the weight ratio between additive and MgO is between 0.2% and 25%.

It is a further object of this invention to disclose a magnesium silico-phosphate cement, comprising: the mixture as defined according to any of the above; and sufficient water to effect hydraulic hardening of said mixture.

It is a further object of this invention to disclose such a magnesium silico-phosphate cement, wherein the ratio of said mixture to water is at least stoichiometric.

It is a further object of this invention to disclose such a magnesium silico-phosphate cement, wherein the ratio of water to said mixture is between 25% and 28% by weight relative to the dry cement mix.

It is a further object of this invention to disclose such a magnesium silico-phosphate cement as defined in any of the above, wherein the compressive strength of a cement cast from said cement, as determined according to standard EN 196-1, is 32 MPa after 3 hours.

It is a further object of this invention to disclose such a magnesium silico-phosphate cement as defined in any of the above, wherein the compressive strength of a cement cast from said cement, as determined according to standard EN 196-1, is 46 MPa after 6 hours.

It is a further object of this invention to disclose such a magnesium silico-phosphate cement as defined in any of the above, wherein the compressive strength of a cement cast from said cement, as determined according to standard EN 196-1, is 49 MPa after 24 hours.

It is a further object of this invention to disclose such a magnesium silico-phosphate cement as defined in any of the above, wherein the compressive strength of a cement cast from said cement, as determined according to standard EN 196-1, is 60 MPa after 7 days.

It is a further object of this invention to disclose such a magnesium silico-phosphate cement as defined in any of the above, wherein the compressive strength of a cement cast from said cement, as determined according to standard EN 196-1, is 65 MPa after 28 days.

It is a further object of this invention to disclose such a magnesium silico-phosphate cement as defined in any of the above, wherein the compressive strength of said cement measured, as determined according to standard EN 196-1, is at least 60 MPa after 28 days.

It is a further object of this invention to disclose a method for advantageously altering the setting time of a magnesium silico-phosphate cement, wherein said method comprises: at least partially coating particles of MgO with an additive; mixing said coated particles of MgO with (a) a phosphate acid or salt provide that will provide a binder product characterized by the empirical chemical formula MMgPO₄.6H₂O and (b) an aggregate phase chosen from the group consisting of CaSiO₃, MgSiO₃, SiO₂, fly ash, sea sand, and any combination thereof; and mixing the product of said step of mixing with a quantity of water sufficient to effect hydraulic setting of said cement.

It is a further object of this invention to disclose such a method for advantageously altering the setting time of a magnesium silico-phosphate cement, wherein said phosphate salt or acid has the chemical formula MₓH_{y}PO₄ (1≦x≦3, y=3−x), M being chosen from the group consisting of H, Li, Na, K, Rb, Cs, NH₄, and any combination of the above.

It is a further object of this invention to disclose such a method for advantageously altering the setting time of a magnesium silico-phosphate cement as defined in any of the above, wherein said binder product is isomorphic with NH₄MgPO₄.6H₂O.

It is a further object of this invention to disclose such a method for advantageously altering the setting time of a magnesium silico-phosphate cement as defined in any of the above, wherein said additive is selected from the group consisting of (a) alkali metal salts of [MF₆]ⁿ⁻, (b) alkaline earth metal salts of [MF₆]ⁿ⁻, (c) HₙMF₆, and (d) any combination thereof; and further wherein M represents any element that can form with fluorine an anion of empirical formula [MF₆]ⁿ⁻ and n represents a positive integer.

It is a further object of this invention to disclose such a method for advantageously altering the setting time of a magnesium silico-phosphate cement as defined in any of the above, wherein M is chosen from the group consisting of (a) P (n=1), (b) Sb (n=1), (c) Si (n=2), (d) Ti (n=2), (e) Zr (n=2), (f) Al (n=3), and (g) any combination thereof.

It is a further object of this invention to disclose such a method for advantageously altering the setting time of a magnesium silico-phosphate cement as defined in any of the above, wherein said additive is a retardant.

It is a further object of this invention to disclose such a method for advantageously altering the setting time of a magnesium silico-phosphate cement as defined in any of the above, wherein said additive is a retardant chosen from the group consisting of (a) Na₂TiF₆; (b) K₂TiF₆; (e) H₂TiF₆; and (d) any combination of the above.

### DETAILED DESCRIPTION OF THE PREFERRED EMBODIMENTS

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore the invention is not limited by that which is illustrated in the figures and described in the specification, but only as indicated in the accompanying claims, with the proper scope determined only by the broadest interpretation of said claims.

We adopt the following definitions in the detailed description that follows:

As used herein, the term “retardant” refers to an additive that is added to a cement or cement mixture that has the effect of lengthening its setting time, i.e. slowing down the rate at which the cast of a cement or cement mixture hardens relative the rate of hardening of a cement's cast or cement mixture's cast that is identical in every way except for the presence of the additive;

As used herein, the term “cement mix” refers to a mixture of dry ingredients that will form a cast upon addition of water.

As used herein, the term “binder” refers to a compound formed during the interaction between the dry cement mix and water that imparts a high compressive strength to the cement's cast.

As used herein, the term “setting” refers to the hardening of the cast.

As used herein, the term “coating” refers to any intimate contact between a substrate and a second material deposited on the surface of the substrate as well as to any process that will produce such intimate contact. Non-limiting examples of coatings according to this definition include one or more layers of the second material on the surface of the substrate, a layer of the second material on the surface of the substrate that partially covers it, absorption and/or adsorption of the second material into pores on the surface of the substrate, layers of the second material on the surfaces of some or all of a collection of particles of the substrate that have formed an aggregate or agglomerate, etc. Note that in the last case, the “coating” may actually be found only in the interior of the aggregate or agglomerate. Similarly, as used herein, a substrate described as being “coated” by another substance refers to a substrate that has undergone a process that will produce a coating thereon according to the above definition of “coating.”

As used herein, the term “particle” refers to any individual microscopic or mesoscopic piece of a substance. The term thus includes, but is not limited to, single crystals, polycrystalline particles, and aggregates and agglomerates of smaller particles.

As used herein, with respect to particles or droplets, the term “size” refers to the diameter of the particle or droplet if it is spherical, and to the length of the longest axis if the particle or droplet has a shape other than spherical.

With reference to quantities, the term “about” refers to an amount within ±20% of the stated quantity. With references to temperatures, the term “about” refers to a temperature within ±5° C. of the stated temperature.

PCT application PCT/IL2009/000139 (henceforth '139), which is hereby incorporated by reference in its entirety, discloses a cement mixture referred to hereafter as “Nova-Set.” The basic formulation for the Nova-Set mixture is a dry mixture of powdered MgO, powdered KH₂PO₄, and an aggregate phase chosen from CaSiO₃ (wollastonite), fly ash, and sea sand. In preferred embodiments of the invention, the dry mix consists of the three components in a weight ratio of about 10:35:55. In the best embodiment of the invention, dead burned MgO is used. In the basic formulation of Nova-Set, water is then added in sufficient quantity (at least stoichiometric) to enable hydraulic hardening of the cement, and the wet mixture is then blended for several minutes until the temperature has risen by 3-5° C. compared with the water's temperature prior to its addition, and then cast.

'139 also disclosed a family of additives for altering the rate of hardening of the Nova-Set cement. These additives were all compounds that contain anions of the general formula [MF₆]ⁿ⁻. For example, when M=Ti or Zr (n=2), the additive is a retardant. For these additives, the counterion is chosen from the group containing H⁺, alkali metal cations, and alkaline earth cations. In the best mode of operation of the invention, M=Ti, the counterion is H⁺, Na⁺ or K⁺, and the additive is present in the cement in an amount of between about 0.05% and about 5% by weight based on the weight of dry cement mix. A typical embodiment contains about 1% by weight of additive based on the dry weight of the final product.

In the protocols disclosed in '139 for addition of an additive for altering the setting time, the additive is added either to the dry Nova-Set mix, which is then mixed with water to form the cast, or the additive is added directly to the water added to the Nova-Set mix to form the cast. The inventors of the present invention have discovered that the additive surprisingly becomes more effective when it is coated onto the particles of MgO rather than added as a separate component. This effect is particularly evident when the additive is a retardant. That is, for example, addition of the same quantity of retardant to the mix according to the present invention provides a longer setting time than its addition according to the protocols disclosed in '139.

Without wishing to be bound by theory, it appears that there are several possible explanations for the observed unexpected improvement in the performance of the additive when it is present as a coating rather than as a separate component of a mixture. It is possible that the intimate contact with the MgO particles ensures more thorough and more uniform mixing of the reactants than adding them separately and mixing would; such intimate contact might also lead to formation of greater amounts of MgTiF₆ from the reaction of MgO with H₂TiF₆ than simple mixing does. When the additive is added as a separate ingredient, it is not possible to guarantee that every encounter between MgO and phosphate will necessarily include an interaction with the additive.

It also possible that the increased effectiveness of the additive when it is present as a coating arises at least in part from physical rather than purely chemical causes. For example, the presence of the additive as a coating may act to prevent direct reaction between MgO and phosphate until the coating has at least partially broken down or eroded, at which point it is automatically in contact with the two reactants. It is also possible that partial coating of the MgO particles by the additive can increase the additive's effectiveness by slowing down the rate at which ions such as MgOH⁺ are released from the particle.

It was also found that the cement mix of the present invention unexpectedly yields a cement product with improved physical characteristics relative to identical cements to which an MF₆ⁿ⁻ retardant has been added according to the protocols disclosed in '139. In particular, the cement has an improved workability relative to that of '139, and is hence easier to cast, and the setting time is significantly extended.

Additional practical advantages of including the rate-altering additive as a coating rather than as a separate ingredient include the possibility of providing the cement mix in a single container and as a single component. In addition, the cement mix of the present invention has less of a tendency to form lumps while it is in its packaging than that of '139, allowing the use of conventional and more environmentally friendly packaging.

In preferred embodiments of the invention, the retardants disclosed in '139 (acids and salts of the general formula AₓMF₆) are used. In preferred embodiments, the retardants are chosen from salts and acids of TiF₆²⁻ and/or ZrF₆²⁻. In the most preferred embodiments, the retardant is chosen from H₂TiF₆, Na₂TiF₆, and K₂TiF₆. In preferred embodiments, the retardant is present in a quantity of between about 0.05% and about 5% by weight relative to the based on the weight of dry cement. A typical embodiment contains about 0.5% by weight of additive based on dry weight of the final product.

The cement mix according to the present invention is prepared as follows. First, the MgO is coated with the additive. The coating is performed by preparing a slurry of retardant in water in a tank with stirring. In preferred embodiments, distilled water is used. In the most preferred embodiments, the retardant used is liquid H₂TiF₆, which is added to the water. Commercially available solutions of H₂TiF₆ in water (generally 50%-60%) may be used. In typical embodiments, the slurry comprises about 0.5-1% TiF₆²⁻ by weight; in preferred embodiments, it comprises about 0.7% by weight. The MgO is then added to the tank; in preferred embodiments of the invention, the ratio of TiF₆²⁻ to MgO is about 0.024 by weight. The inventors have found that in the preparation the slurry, the ratio between the weight of retardant and the weight of the MgO is a more significant parameter than the concentration of solids in the slurry for determining the quality of the final dried product. The optimal amount of water in the slurry, as will be appreciated by those skilled in the art, is the minimum volume that will allow easy feeding of the slurry to the dryer, since the use of the minimum amount of water possible will minimize the costs of evaporating the water in the dryer. The inventors have found that the best results were obtained when the slurry comprises less than about 30% solids; higher concentrations tend to lead to solidification of the slurry within the spray-dryer.

The product of the MgO addition (i.e. a slurry of MgO/TiF₆²⁻ in water) is then dried to form particles of coated MgO. In preferred embodiments, a spray dryer is used. In preferred embodiments of the invention, the spray dryer is run under operating conditions such that the air exiting the spray dryer has a temperature of at least 100° C. In the most preferred embodiments, the temperature of the air exiting the spray dryer is about 105° C. Optimization of other spray dryer conditions is performed according to methods well-known in the art.

In typical embodiments of the invention, at least 90% of the coated MgO particles produced by the method disclosed herein have sizes of between 0.1 μm and 100 μm, as measured by laser diffraction.

The coated MgO particles are then mixed with a phosphate acid salt (in preferred embodiments, KH₂PO₄ or (NH₄)H₂PO₄) and the aggregate to form the cement mix. In preferred embodiments of the invention, the weight ratio of the three phases is 20:35:45.

To form the cast, the dry cement mix is mixed with a quantity of water (at least stoichiometric) sufficient to effect hydraulic setting of the cement. In preferred embodiments of the invention, the amount of water added is between about 25% and about 28% w/w relative to the dry cement mix.

### EXAMPLE

As a non-limiting example of one embodiment of the present invention, results are presented for the production of a cement cast as described above. 2000 g of the dry cement mix prepared as described above with a 20:35:45 MgO:phosphate:aggregate weight ratio, and comprising 0.5% (w/w) H₂TiF₆ retardant coated on the MgO particles, was mixed with 500 g of water. The cement was then mixed for several minutes until the temperature rose by 3-5° C. relative to the temperature of the water prior to its addition, as measured by an IR thermometer. The cement was then cast. The values reported in the table represent averages of several independent measurements.

For comparison, cement casts were produced that included TiF₆²⁻ retardant added according to two embodiments of the protocol disclosed in '139. In one case, powdered K₂TiF₆ (1% w/w) was added to 2000 g of the dry cement mix, 500 g of water was added, and the cement then mixed and cast as described above. In the second case, a solution of H₂TiF₆ in 500 g of water was prepared (1.9% w/w=0.5% w/w relative to the dry cement mix), 2000 g of dry cement mix (i.e. without retardant) was added to the suspension, and the cement then mixed and cast as described above. The results of these experiments are also summarized in Table 1.

TABLE 1

| | | | | cement | cement cast | |
|---|---|---|---|---|---|---|
| | | | | cast | according to | |
| | | | | according | protocol of ′139 | |
| | | | time | to the | K₂TiF₆ | |
| Char- | | | after | present | in | H₂TiF₆ |
| acteristic | Standard | units | mixing | invention | dry mix | in water |
| Com- | EN196-1 | MPa | 3 h | 32 | 41 | 3 |
| pressive | | | 6 h | 46 | 45 | 50 |
| strength | | | 1 d | 49 | 46 | 61 |
| | | | 7 d | 60 | 53 | 75 |
| | | | 28 d | 65 | 62 | 79 |
| Initial | EN196-3 | min | | 45 | 27 | 24 |
| setting | | | | | | |
| time | | | | | | |
| (20° C.) | | | | | | |
| Final | EN196-4 | min | | 48 | 31 | 27 |
| setting | | | | | | |
| time | | | | | | |
| (20° C.) | | | | | | |
| Work- | EN12350-5 | mm | | ≧255 | 175 | 165 |
| ability | | | | | | |
| Lumping | in-house | | | no | yes | yes |
| | method | | | | | |

The instrument upon which the measurement of the workability of the cement cast is to be made according to standard EN12350-5 cannot measure a workability greater than 255 mm. In the experiment the results of which are reported in the table, the workability was found to have at least this value, i.e. the workability was actually greater than the maximum that can be determined by standard EN 12350-5.

The results presented in the table clearly demonstrate that the cement cast prepared according to the present invention has longer initial and final setting times in comparison to cement casts prepared by adding retardant separately either to the dry cement mix or to the water. Moreover, the observed increase in the setting times is obtained without compromising the compressive strength of the final cement cast.

1-47. (canceled)

48. A mixture suitable for use in forming a magnesium silico-phosphate cement, said mixture comprising:
particles of MgO;
an additive;
a phosphate salt or acid selected from the group consisting of:
phosphate salts and acids that will provide a binder product characterized by the empirical chemical formula MMgPO₄.6H₂O;
phosphate salts and acids that will provide a binder product the crystal structure of which is isomorphic with NH₄MgPO₄.6H₂O; and,
phosphate salts and acids having the chemical formula MₓH_{y}PO₄ (1≦x≦3, y=3−x), M being selected from the group consisting of H, Li, Na, K, Rb, Cs, NH₄, and any combination of the above; and,
an aggregate phase selected from the group containing (a) CaSiO₃, (b) MgSiO₃, (c) SiO₂, (d) fly ash, (e) sea sand, and (f) any combination thereof;
wherein said particles of MgO are at least partially coated with said additive.

49. The mixture according to claim 48, wherein said additive is a retardant.

50. The mixture according to claim 48, wherein said additive is selected from the group consisting of (a) alkali metal salts of [MF₆]ⁿ⁻, (b) alkaline earth metal salts of [MF₆]ⁿ⁻, (c) HₙMF₆, and (d) any combination thereof, where M represents any element that can form with fluorine an anion of empirical formula [MF₆]ⁿ⁻ and n represents a positive integer.

51. The mixture according to claim 50, wherein M is selected from the group consisting of (a) P (n=1), (b) Sb (n=1), (c) Si (n=2), (d) Ti (n=2), (e) Zr (n=2), (f) Al (n=3), and (g) any combination thereof.

52. The mixture according to claim 51, wherein said additive is selected from the group consisting of (a) Na₂TiF₆; (b) K₂TiF₆; (c) H₂TiF₆; and (d) any combination of the above.

53. The mixture according to claim 48, wherein said additive is present in an amount of between 0.05% and 5% by weight based upon the weight of dry cement.

54. The mixture according to claim 48, wherein the particle size of said particles of MgO is between 0.1 μm and 100 μm.

55. The mixture according to claim 48, wherein said additive is coated upon said particles of MgO in a thickness of at least 0.5 monolayer.

56. The mixture according to claim 48, wherein said MgO particles at least partially coated with additive are the products of a process comprising steps of preparing a slurry by adding said additive to water; adding said particles of said MgO to said slurry; feeding said addition product to a spray dryer; and spray-drying said addition product, thereby producing coated particles of MgO.

57. The mixture according to claim 48, wherein the ratio of uncoated MgO:phosphate:aggregate is about 20:35:45 by weight.

58. A method for producing a mixture suitable for use in forming magnesium silico-phosphate cement, said method comprising:
preparing a slurry comprising:
an additive effective for altering the setting time of a magnesium silico-phosphate
cement; and,
water;
adding MgO to said slurry;
feeding the product of said step of adding MgO to said slurry into a dryer;
drying said product, thereby producing particles of MgO at least partially coated with said additive; and,
mixing said at least partially coated particles of MgO with said phosphate salt or acid and aggregate.

59. The method according to claim 58, wherein said step of feeding the product of said step of adding into a dryer comprises feeding the product into a spray dryer, and said step of drying comprises spray drying.

60. The method according to claim 59, wherein said step of spray drying comprises operating said spray dryer under at least one condition selected from the group consisting of:
operating said spray dryer under conditions effective to produce droplets characterized of sizes between 0.1 μm and 200 μm;
operating said spray dryer under conditions effective to produce particles, at least 90% of which have sizes of between 0.1 μm and 100 μm;
maintaining the temperature of the air exiting the spray dryer above 100° C.; and, maintaining the temperature of the air exiting the spray dryer at about 105° C.

61. The method according to claim 58, wherein said additive is selected from the group consisting of H₂TiF₆, Na₂TiF₆, K₂TiF₆, and any combination of the above.

62. The method according to claim 58, wherein the weight ratio between MgO and additive is between 0.2% and 25%.

63. A magnesium silico-phosphate cement, comprising:
the mixture according to claim 48; and,
sufficient water to effect hydraulic hardening of said mixture.

64. A method for advantageously altering the setting time of a magnesium silico-phosphate cement, comprising:
at least partially coating particles of MgO with an additive;
mixing said at least partially coated particles of MgO with:
a phosphate acid or salt selected from the group consisting of:
phosphate salts and acids that will provide a binder product characterized by the empirical chemical formula MMgPO₄.6H₂O;
phosphate salts and acids that will provide a binder product the crystal structure of which is isomorphic with NH₄MgPO₄.6H₂O; and, phosphate salts and acids having the chemical formula MₓH_{y}PO₄ (1≦x≦3, y=3−x), M being selected from the group consisting of H, Li, Na, K, Rb, Cs, NH₄, and any combination of the above; and,
an aggregate phase selected from the group consisting of CaSiO₃, MgSiO₃, SiO₂, fly ash, sea sand, and any combination thereof; and,
mixing the product of said step of mixing with a quantity of water sufficient to effect hydraulic setting of said cement.

65. The method according to claim 64, wherein said additive is selected from the group consisting of (a) alkali metal salts of [MF₆]ⁿ⁻, (b) alkaline earth metal salts of [MF₆]ⁿ⁻, (c) HₙMF₆, and (d) any combination thereof, where M represents any element that can form with fluorine an anion of empirical formula [MF₆]ⁿ⁻ and n represents a positive integer

66. The method according to claim 65, wherein M is selected from the group consisting of (a) P (n=1), (b) Sb (n=1), (c) Si (n=2), (d) Ti (n=2), (e) Zr (n=2), (f) Al (n=3), and (g) any combination thereof.

67. The method according to claim 64, wherein said additive is a retardant.
